(19) United States
(12) Patent Application Publication
(10) Pub. No.: US 2005/0097977 A1
(43) Pub. Date: May 12, 2005

(54) Transmission systems

(76) Inventor: Dale E. Van Cor, Winchester, NH (US)

Correspondence Address: Lawson & Persson, P.C.;Suite 103, 67 Water Street, Laconia, NH, 03246, US

(21) Appl. No.: 10/939,984

(22) Filed: Sep. 13, 2004

Related U.S. Application Data
(60) Provisional application No. 60/502,708, filed on Sep. 12, 2003.

(51) Int. Cl. F16H 48/06

(52) U.S. Cl. 74/462

(57) ABSTRACT

A transmission that functions as a combination friction drive and gear tooth drive: The transmission utilizes VCT conic teeth added to the surface of a variable pulley. The teeth in the sides of a continuous loop, or a two-faced gear, engage the teeth on this conic surface. When the pulleys contract or expand, the top of the teeth engage the surface frictionally. When the contraction or expansion of the pulleys move the continuous loop, or two-faced gear, to the next ring of conic teeth, it engages the conic teeth as a toothed drive.

### CLAIM OF PRIORITY

This application claims the benefit of priority of U.S. Provisional Patent Application Ser. No. 60/502,708, filed Sep. 12, 2003.

### FIELD OF THE INVENTION

The present invention relates to the field of transmissions and, in particular, to transmissions utilizing cones to vary the speed of transmission components.

### BACKGROUND OF THE INVENTION

The inventor of the present application is the inventor of two related and co-pending applications, which each disclose arrangements of gears and systems utilizing these arrangements. U.S. Pat. No. 6,543,305, invented by the inventor of the present invention and incorporated herein by reference, discloses and claims a gear train and transmission system called the VCT and is hereafter referred to as the “VCT patent”. U.S. Pat. No. 6,499,373, also invented by the inventor of the present invention and incorporated herein by reference, discloses and claims a stack of gears and transmission system called the VCT2 and is hereafter referred to as the “VCT2 patent”.

The VCT transmission system includes a pinion gear having a plurality of helical teeth. A cone is disposed in contact with the pinion gear and includes a plurality of conic teeth and a plurality of scaling teeth. The conic teeth are arranged about the cone to form a plurality of conic rings disposed about a plurality of nascention circles on the cone. The conic teeth of the conic rings are dimensioned to mate with the helical teeth of the pinion gear such that the conic teeth neutralize a change in surface speed of the cone along the conic teeth. The scaling teeth are in the tube portion of at least one acceleration channel and at least one deceleration channel extending from each of the conic rings and intercepting an adjacent conic ring and the acceleration channel and deceleration channel are disposed along a nascention offset line between nascention circles of adjacent conic rings.

The VCT2 utilizes a stack of gears, which includes a second gear disposed in parallel relation to, and sharing a common axis with, the first gear. Each gear is of a different diameter and each includes a plurality of teeth. At least one transition train has teeth disposed between the first gear and the second gear. Like the first and second gear, the transition train also includes a plurality of teeth that are disposed in substantially perpendicular relation to the common axis. The transition train is dimensioned to form at least one deceleration channel and at least one acceleration channel extending from each of the first gear and the second gear. The VCT transmission system also includes a mating member dimensioned to mate with the first plurality of teeth, the second plurality of teeth, and the third plurality of teeth of the stack of gears. In some embodiments, this mating member is a pinion gear, while in others it is a ring gear or continuous loop drive, such as a chain, a toothed belt, a V-belt, or a flat belt drive.

In operation, the pinion gear or other mating member of either the VCT or VCT2 moves about a given conic ring or gear at a substantially constant speed until a higher or lower speed is desired. If a higher speed is desired, the mating member is moved through an acceleration channel, which allows the gear to move to a higher conic ring or gear. If a lower speed is desired, the mating member is moved through a deceleration channel, which allows the member to move to a lower conic ring or gear.

The VCT2 is fundamentally different from the VCT in six distinct ways. First, the axis of the pinion gear in the VCT2 is parallel with the axis of the cone, where the VCT has the gear axis parallel to the face of the cone. Second, the conix formula does not apply as the pinion gear can be a spur gear or any helical gear. Third, the VCT cone does not have to be a cone in the VCT2, as the angle between the ring gears can be constant, varied or curved. Fourth, the embodiment of the VCT described in FIG. 62 of the '407 application will not work with the VCT2, as the shaft of the pinion gear is for controlling the position of the gear. Fifth, the VCT Felch cascade configuration will not work with the VCT2 because the cone cannot move independently and lateral movement of the inner and outer shaft would be unworkable. Sixth, the Persson configuration of the VCT2, will not work with the VCT because the axes of all gears are parallel to each other.

The VCT2 is also similar to the VCT in many ways. For example, vector loading of the VCT applies directly to embodiments of the VCT2 where the first and second gears are helical gears, as these can still experience sideways pressure to move to a higher or lower gear range due to the vectoral force applied to the helical surface. In such an embodiment, the stack of gears of the VCT2 may have different helical teeth based on the environment. For example, a high torque environment would require a smaller helical angle then the lower torque, so that it did not move to easily.

Another similarity is in the designs of the acceleration and deceleration channels as the lateral motion in each should be an S-curve. Further, as with many embodiments of the VCT, embodiments of the VCT2 have an entrance, acceleration and deceleration tube and an exit. The speed in the entrance is the speed of the departing ring gear and the speed of the exit is the speed of the arriving ring gear. The tube is where the speed changes on a fractional basis making the change in speed continuous as opposed to stepped.

Yet another similarity is that both follow the same footprint analysis when laying out the movement of pinion gear through the channels is very similar, with both the VCT and VCT2 being adaptable for use with a variety of alignment and control surfaces.

Although both the VCT and VCT2 are well suited to a wide variety of applications, they are not well suited for hostile environments and are not cost effective for some low cost applications.

For example, the VCT and VCT2 require the use of a precise position tracking system for changing speeds. Accordingly, the VCT and VCT2 are physically limited in how fast they can change speeds due to this position tracking. The length and degrees of rotation of the channels lock in the relationship with the input/output RPMs and how fast it cross the channels; which becomes more severe with higher speeds.

In addition, the VCT and VCT2 are neither cheap nor simple to make and, therefore, are not well suited for lawn tractor and other low torque, low cost applications.

Therefore, there is a need for a transmission system that provides the advantages of the VCT and VCT2, that does not require the use of a precise position tracking system for changing speeds, that is simpler and less costly to make than the VCT and VCT2.

### SUMMARY OF THE INVENTION

The Van Cor Transmission Three (hereafter VCT3) is a combination of a friction drive and a gear tooth drive. The preferred embodiment is based on the VCT conic teeth added to the surface of a variable pulley. The teeth in the sides of continuous loop of a two-faced gear engage the teeth on this conic surface. When the pulleys contract or expand, the top of the teeth engage the surface frictionally. When the contraction or expansion of the pulleys move the continuous loop or two-faced gear to the next ring of conic teeth it engages the conic teeth as a toothed drive. However, it is equally applicable to fixed gears rather than variable pulleys.

The benefit of the system is that the high wear friction component is only engaged when changing speeds. The low wear toothed engagement is the primary operation of the system. Changing speeds is very quick and thus efficient. The slippage is at a minimum due to the matching surface design of the Anair Surface Interface of the teeth that also translates to the surfaces. The portion of teeth engaged in the conic teeth engages the cone frictionally as well. This high surface contact minimizes slippage. The system controls are on variable pulleys which may utilize a rocker arm assembly that contracts and expands the pulleys in equal and opposite directions, or other art recognized variable pulleys.

The conic surface has to obey the conix formula to keep the slippage at a minimum. As explained in detail in the inventor's co-pending VCT patent applications, the conix formula is:
conix angle=arcsine (1/(2×pi×tan (90-helix angle)).
The conix formula will produce an angle for the cone called the conix angle that is based on a desired helix angle. The result is a surface on which a plurality of conic teeth can be derived based on a plurality of nascention coordinates. These nascention coordinates are the starting points of the conic teeth. The distance between each tooth's nascention coordinate is the circular pitch of the helical gears teeth.

From the nascention coordinate, pitch lines are extended upwards and downwards based on the nascention coefficient. A nascention coefficient is the rate of change in distance rho with angle of rotation theta; i.e. turning the cone theta degrees results in a rho equal to the distance up or down the cone. These pitch lines are actually mathematical spirals. Moving up the cone to a larger diameter will produce an ascending pitchline. Moving down the cone to a smaller diameter will produce a descending pitchline.

The pitchline of the pinion gear's helical tooth is also a function of a distance rho per degree of rotation theta, but the result is curved pitchline as opposed to the spiral pitchline of the cone. When rolling against the ascending spiral pitchline, there are an increasing number of points on the spiral pitchline than the curved pitchline. This results in ascending sliding, similar to worm gear sliding. This is referred to as cone sliding. This cone sliding starts at zero from the nascention coordinate and increases at a constant rate. The descending spiral pitchline has fewer points of contact with the curved pitchline. This sliding is called pinion sliding.

The system has to be designed for this sliding to be in the realm of lubrications. Involute profiled teeth have a sliding function as well, which is why they need some lubrication. In practical terms, this sliding can be kept to less the 0.5%, well within the range of lubrication. With the VCT3 employing the Anair surface interface, the surfaces are matching and there isn't any ascending or descending sliding.

For the VCT3 this means that the conic teeth will mate with the helical teeth or other conic teeth in a manner the keeps sliding and its resultant wear to a minimum. However, gears need lubrication, and friction based components cannot be lubricated. This means that low wear materials, which do not need lubrication, are best suited for use in VCT3 applications.

The friction surface works best when there is a large surface of contact. The configuration that provides the most is the Wickers Cascade, described below, which utilizes variable cone-pulleys. There are two opposed cones and thus two surfaces which a continuous loop belt or chain is wrapped around. This wrapping can be 50% and upwards of cone surface contact on two cones surfaces.

Applying the conix formula to the present application, a conic angle of 45 degrees would yield a helix angle of 77 degrees. When used with a belt, this formula is applied to form sharp teeth that pull the teeth in for a tight hold on a belt. The opposite is applied to the links of a chain, where compression against the links can produce a tight hold.

The dynamics of a continuous loop are a very large tooth contact ratio. The practical minimum may be 40% of teeth contacting the conic surface of the pulley against the belt/chain teeth.

There are three types of friction-tooth transmissions: A Graham Cascade, Tourgee Cascade and a Whicker Cascade. The Graham Cascade is a gear between two variable conic pulleys. A Tourgee Cascade is a ring around two variable conic pulleys. The Whicker Cascade is a continuous loop around two variable conic pulleys. It has two types: belt and chain. The belt is flexible and it is preferred that the design of the teeth on the conic pulleys angles the teeth inwards to pull on the belt. Conversely, the chain is hard and it is preferred that the teeth on the conic pulleys be designed to compress, or push on, the chain to keep it taut. A sharp helix angle on gear teeth would increase the vectoral force on the helical teeth due to the small contact ratio of less then 2.0. The continuous loop would typically have 50% plus tooth contact. This would distribute the vectoral force around half of the cones. Finally, the Tourgee and Whicker Cascade have matching surfaces making them the preferred applications.

Therefore, it is an aspect of the invention to provide a transmission system in which that the high wear friction component is only engaged when changing speeds.

It is a further aspect of the invention to provide a transmission system in which low wear toothed engagement is the primary operation of the system.

It is a further aspect of the invention to provide a transmission system in which changing speeds is very quick and thus efficient.

It is a further aspect of the invention to provide a transmission system in which slippage is at a minimum.

It is a further aspect of the invention to provide a transmission system in which the portion of teeth engaged in the conic teeth engages the cone frictionally as well, creating a high surface contact and minimizing slippage.

It is a further aspect of the invention to provide a transmission system in which the system controls are on variable.

It is a further aspect of the invention to provide a transmission system that can take tens or more revolutions to complete a transition form one speed to another.

It is a further aspect of the invention to provide a transmission system in which the transition speed can vary with the input/output RPMs.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a side view of friction tooth transmission with a conic gear in two positions.

FIG. 2 is a diagrammatic side view of a friction tooth.

FIG. 3 is a diagrammatic top view of a friction tooth.

FIG. 4 is a diagrammatic top view of a formation of friction teeth.

FIG. 5 is a view of friction teeth in mesh with another gear tooth.

FIG. 6 is top view of FIG. 7.

FIG. 7 is a Graham Cascade with a two-faced conic gear configuration of a friction tooth transmission.

FIG. 8 is a bottom view of FIG. 7.

FIG. 9 is a top view of FIG. 10.

FIG. 10 is a second Graham Cascade with a two-faced helical gear configuration of a friction tooth transmission.

FIG. 11 is a bottom view of FIG. 10.

FIG. 12 is a third Graham Cascade with a conic gear between parallel cones configuration of a friction tooth transmission.

FIG. 13 is a bottom view of FIG. 13.

FIG. 14 is a view of FIG. 13 with the cones at their extreme positions.

FIG. 15 is a fourth Graham Cascade with a two-faced conic gear between two variable pulley configuration of a friction tooth transmission. The pulleys are in their extreme positions.

FIG. 16 is a forth Graham Cascade with a two-faced conic gear between two variable pulley configuration with the pulleys in a different position.

FIG. 17 is a top view of FIG. 18.

FIG. 18 is a Tourgee Cascade with a two-faced conic ring gear shown in its extreme positions around two opposed cone configuration of a friction tooth transmission.

FIG. 19 is a bottom view of FIG. 18.

FIG. 20 is a Tourgee Cascade with a helical ring gear shown at its extreme positions around two opposed cone configuration of a friction tooth transmission.

FIG. 21 is a Tourgee Cascade with a conic ring gear around two parallel cone configuration of a friction tooth transmission. The cones are in their extreme positions.

FIG. 22 is Tourgee Cascade with a conic ring gear around two parallel cones in their middle positions.

FIG. 23 is a bottom view of FIG. 22.

FIG. 24 is a Tourgee Cascade with a two-faced conic ring gear around variable pulley configuration of a friction tooth transmission. The pulleys are in their extreme positions.

FIG. 25 is a Tourgee Cascade with a two-faced conic ring gear with the variable pulleys in the middle position.

FIG. 26 is a bottom view of FIG. 25.

FIG. 27 is a Felch Cascade configuration of a friction tooth transmission. The internal and external helical gears are shown in extreme positions.

FIG. 28 is a cut-away of FIG. 27.

FIG. 29 is a Whicker Cascade with a conic tooth belt between parallel cone configuration of a friction tooth transmission.

FIG. 30 is a bottom view of FIG. 29.

FIG. 31 is a top view of FIG. 32 showing the top most position of the continuous loop.

FIG. 32 is a Whicker Cascade with a two-faced conic tooth continuous loop configuration of a friction tooth transmission. The continuous loop is shown in two extreme positions.

FIG. 33 is a bottom view of FIG. 32 showing the bottom most positions of the continuous loop.

FIG. 34 is a Whicker Cascade with a two-face conic tooth belt between a variable pulley configuration of a friction tooth transmission. The variable pulleys are shown in their extreme positions.

FIG. 35 is a Whicker Cascade with a two-face conic tooth continuous loop between variable pulleys at their middle positions.

FIG. 36 is a bottom view of FIG. 35.

FIG. 37 is a cut-away view a cone in the variable pulleys of FIG. 34-36. This displays the angle and relative position of the teeth.

FIG. 38 is a side view of FIG. 37 showing the teeth relative to each other.

FIG. 39 is a Whicker Cascade with a two-faced chain between variable. The pulleys are at they middle position.

FIG. 40 is a cut-away view of FIG. 39.

FIG. 41 is a Whicker Cascade with a two-faced chain with the pulleys in their extreme positions.

FIG. 42 is a cut-away view of FIG. 41.

FIG. 43 is cut-away view of a cone in the variables pulleys in FIG. 39-42.

FIG. 44 is a side view of FIG. 42 showing the relative position of the teeth.

### DETAILED DESCRIPTION OF THE INVENTION

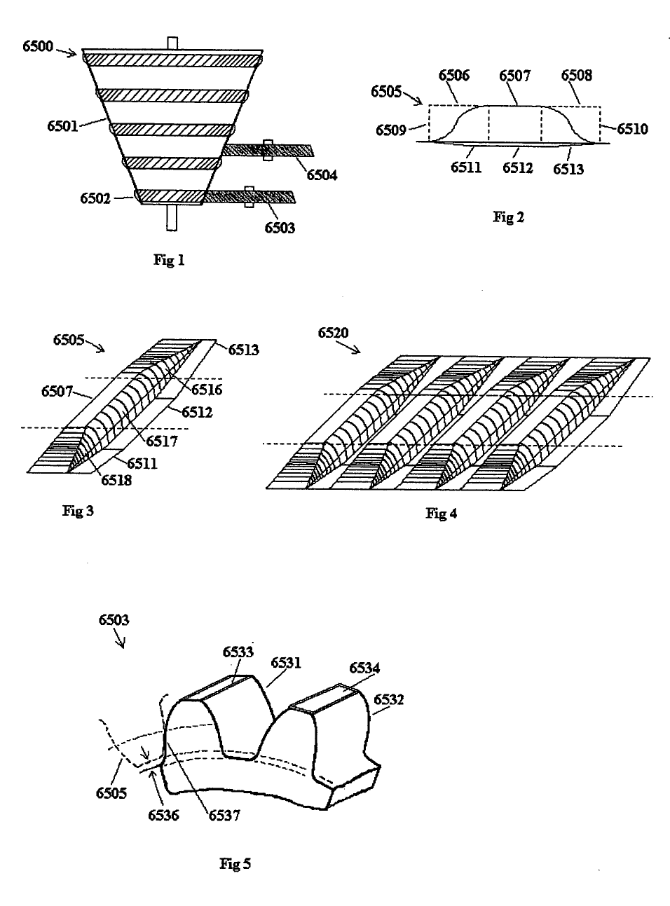

The basic principle of a friction tooth drive 6500 is explained with reference to FIGS. 1-5. Cone 6501 with ring teeth 6502 is engaged with a conic gear 6503. This is an Ashbey surface interface. A side view of a ring tooth 6502 on the friction tooth cone, referred to herein as a “friction tooth 6505” is shown in FIG. 2 as a conic tooth with portions 6509, 6510 removed; leaving sloped ends 6506, 6508 and a mid-section 6507. The mid-section 6507 is where normal tooth engagement occurs. The sloped ends have two functions; it provides the friction tooth 6505 with a place to slide onto a conic tooth converting from a friction to a tooth drive, and provides the friction tooth 6505 with a place to slide from a conic tooth to a friction surface converting back to a friction drive. The tooth space 6511, 6512, 6513 in FIG. 2 and FIG. 3 shows the cone's surface ramping down 6511 to a normal clearance space 6512 for meshing teeth. When the friction tooth 6505 is slid from the conic teeth to the friction surface, the clearance space 6512 is ramped up 6513 to the surface for friction contact on the top of the teeth 6505.

FIG. 3 is the conic tooth 6505 diagramming the ends 6516, 6518 and the mid-section 6517 as tooth profiles. The ends 6516, 6518 are the transition areas where the conic gear changes from a friction surface drive to a toothed drive. These ends form a ramp 6513 upward for the tooth to engage the surface. If the conic gear tooth is not mating in the tooth space, then it will be at a larger diameter. This, by nature, means that it will both slip and turn faster than the surface diameter until the teeth engage. The falling contact surface 6511 will direct the force from the friction surface to the involute sides of the teeth 6517. FIG. 4 shows the arrangement of a plurality of ring teeth 6505 collectively.

In FIG. 5 the gear 6503 has teeth 6531, 6532 with tops 6533, 6534 that engage the surface of the cones frictionally. The tops 6533, 6534 of the teeth 6531, 6532 have to have clearance distance 6536 for meshing with conic teeth 6505 so any material added to these tops 6533, 6534 cannot interfere in the tooth space 6512. When the teeth 6531 engage conic teeth 6505 it does so on its involute surfaces 6537. When it slides out of the ring teeth it transitions from engaging the conic teeth 6505 to engaging the surface 6501 of the cone 6500.

It is important to note that the conversion from conic teeth to friction teeth change the relative pitch circles. The pitch diameter of the gear extends to the top of the gear and the pitch diameter of the cone extends to the surface of the cone, which changes the relative gear ratios of the pitch circles.

In some embodiments, the top of the gear 6533, 6534 has a soft cushioning material that is compressed when engaged with the conic gears surface. In others, where compression is not desired, the top of the gear 6533, 6534 is hard.

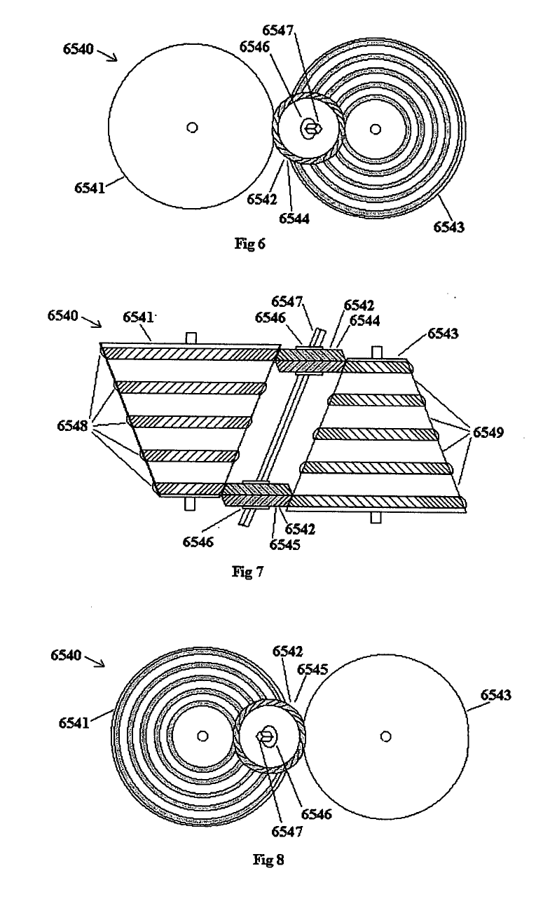

Referring now to FIGS. 6-8, one of four friction tooth Graham Cascade embodiments is shown. FIG. 7 is a diagram of a Graham cascade 6540 with two-faced conic gear. The Graham Cascade 6540 is a two-faced friction tooth gear 6542 between two friction tooth cones 6541, 6543 in opposed positions. The two-faced friction tooth gear 6542 is an Ashbey surface interface and is shown in two extreme positions 6544, 6545. FIG. 6 is a top view of FIG. 7 showing the two-faced gear 6542 in the extreme top position 6544. FIG. 8 is a bottom view of FIG. 7 showing the two-faced gear 6542 in the extreme bottom position 6545.

FIG. 7 shows the two-faced gear 6542 engaging the conic teeth 6548 at the top 6544 and bottom 6545 positions. Between the conic teeth 6548 is the friction surface 6549 that the conic gear is in frictional contract with between the conic teeth 6548. The axis of the two-faced gear 6542 is not aligned with its rail 6547. Therefore, it is mounted on a slidable bearing 6545, which is mounted on rail 6547, which is shown as a square shaft, but may take many art-recognized forms. In this Graham configuration 6540, the cones 6541, 6543 stay stationary and the gear 6542 moves to change gear ratios.

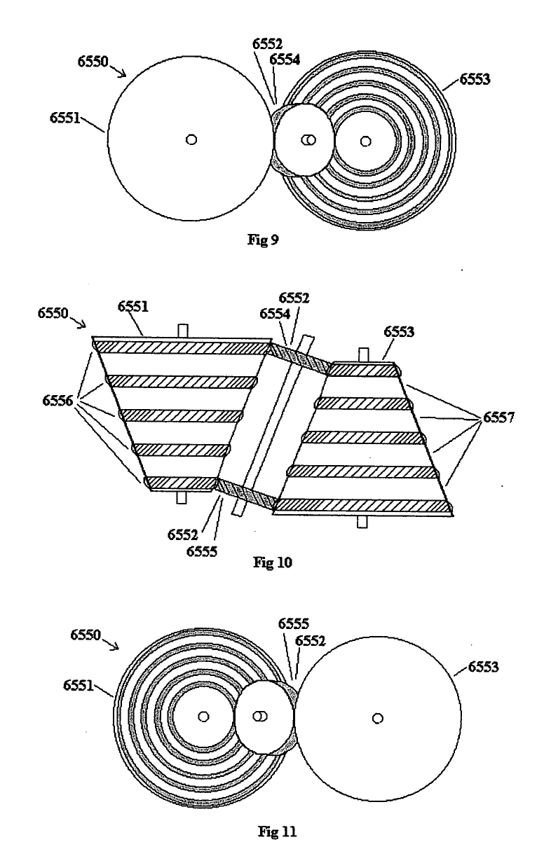

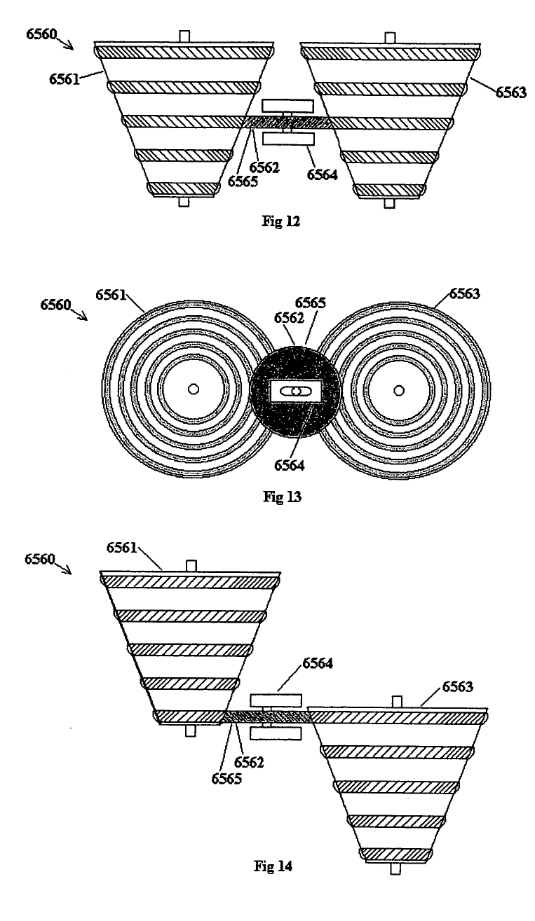

FIGS. 9-11 show a second friction tooth Graham cascade 6550 embodiment, which uses a helical gear. In this embodiment, a pinion gear 6552 is disposed between two opposed friction tooth cones 6551, 6553 creating a Tatham surface interface. FIG. 10 is a side view of a diagram showing the pinion gear 6552 in two extreme positions 6554, 6555. FIG. 9 is a top view of FIG. 10 with the pinion gear 6552 in the top extreme position 6554. FIG. 11 is a bottom view of FIG. 10 with the pinion gear 6552 in the bottom position 6555. In this embodiment, the cones 6551,6553 stay stationary and the helical gear 6552 changes position to change gear ratios.

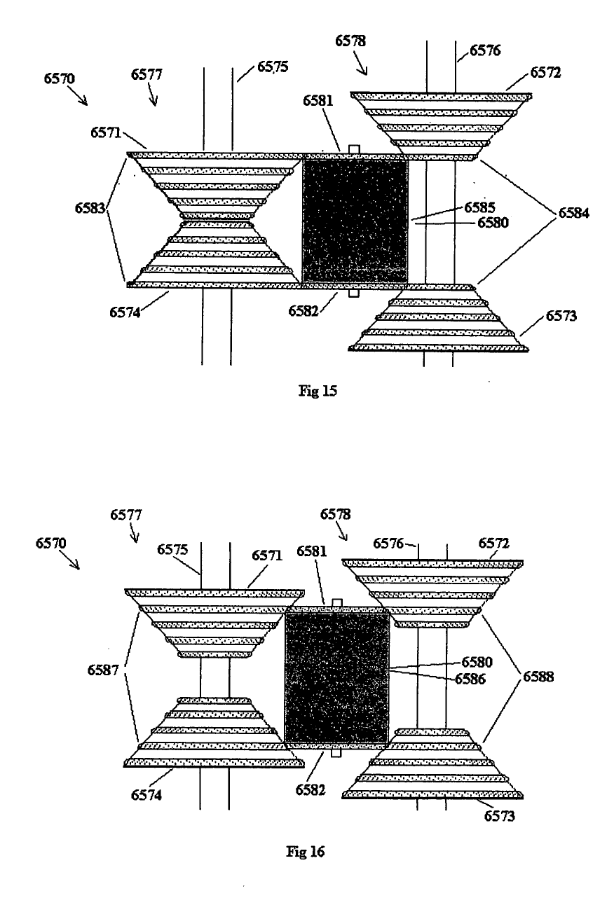

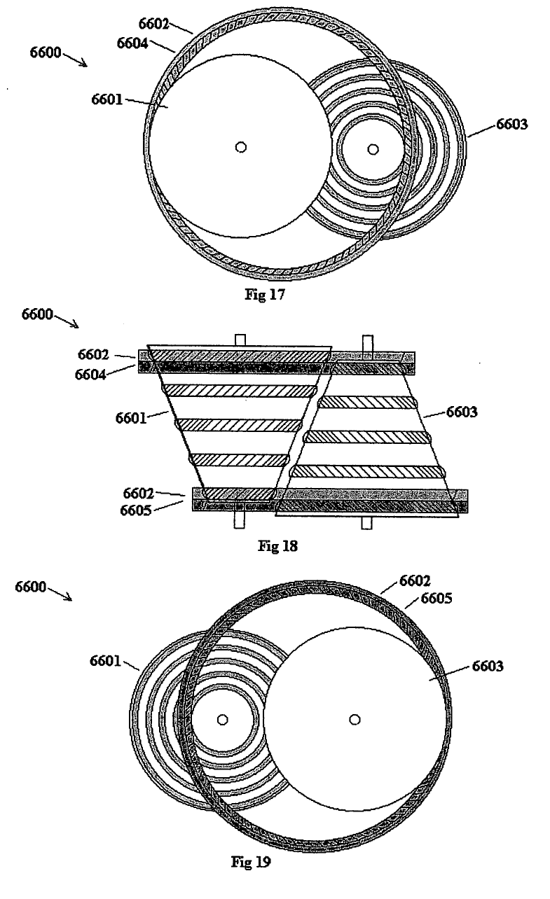

FIGS. 12-14 show a third friction tooth Graham cascade 6560 embodiment, which uses a conic gear 6562 between parallel cones 6561,6563. In this embodiment, a friction tooth conic gear 6562 is disposed between two parallel friction tooth cones 6561,6563 in an Ashbey surface interface. FIG. 12 is a side view diagram 6560 showing the conic gear 6562 in the middle position at position 6565. FIG. 13 is a bottom view of FIG. 12, while FIG. 14 is a side view showing the cones in an extreme position and the conic gear 6562 at position 6566. The pinion gear 6562 moves laterally relative to the sides of the cones. The cones 6561, 6563 moves up and down in equal and opposite directions while maintaining the respective distance for the conic gear 6562 to stay engaged. The axis of the cones 6561,6563 stays parallel. The gear mounting 6564 stays at the same location, but the conic gear 6562 moves laterally.

The forth Graham Cascade 6570 embodiment, shown in FIGS. 15 and 16, is made up of a friction tooth two-faced conic gear 6580 between two sets of variable friction tooth cone pulleys 6570, 6578. This is an Ashbey surface interface. The cones are similar to the parallel cones in 6560, except there are two sets of parallel cones 6571, 6572 and 6574, 6573 in opposite orientation sharing the same shafts 6575, 6576 respectively. FIG. 15 has cones 6571, 6574 on shaft 6775 creating a variable friction tooth conic pulley 6577. The cones, 6572, 6573 on shafts 6576 create a second variable friction tooth conic pulley 6578. These variable friction tooth conic pulleys 6577, 6578 are positioned side by side and move in equal and opposite directions maintaining the engagement of conic gear 6580.

In FIG. 15, the gear face 6581 is in mesh with conic teeth 6583, 6584 and gear face 6582 is in mesh with conic teeth 6585,6586. To change speeds, cone pulley 6577 opens and the other cone pulley 6578 closes, resulting in the cones having the relative positions shown in FIG. 16. In the process, the two-faced gear moves laterally from position 6592 in FIG. 15 left to position 6593 in FIG. 16. The teeth on the gear face 6581 moved from conic teeth 6583, 6584 to conic teeth 6588, 6589 respectively, as well as the teeth on gear face 6582 moved from conic teeth 6585, 6866 to conic teeth 6590, 6591 respectively. FIG. 15 is the extreme positions; pulley 6577 is completely closed and pulley 6578 is completely open.

In addition to the Graham cascade embodiments described above, there are four distinct friction tooth Tourgee cascades embodiments. The first, shown in FIGS. 17-19, is a friction tooth two-faced ring gear around a pair of opposed friction tooth cones, which utilizes an Anair surface interface. FIG. 18 shows the transmission 6600 consisting of opposed cones 6601,6603 with two-faced conic ring 6602 shown in two extreme positions 6604,6605. The two faces 6606,6607 of the ring gear 6602 can be seen in the top and bottom view. FIG. 17 is top view of FIG. 18 showing only face 6606 of ring gear 6602 and FIG. 19 is the bottom view showing face 6607 of ring gear 6602.

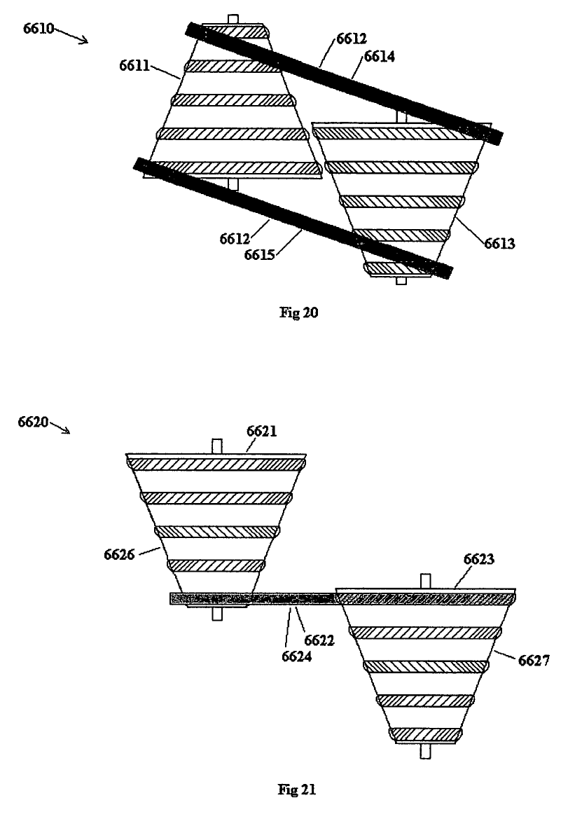

A second Tourgee Cascade 6610 embodiment, shown in FIG. 20, is a friction tooth helical ring gear 6612 around two opposed friction tooth cones 6611, 6613, which utilizes a Tatham surface interface. The ring gear 6612 is shown in two extreme positions 6614, 6615. To change from one conic ring of teeth to another, only the ring moves, while the cones stay relatively stationary to the ring.

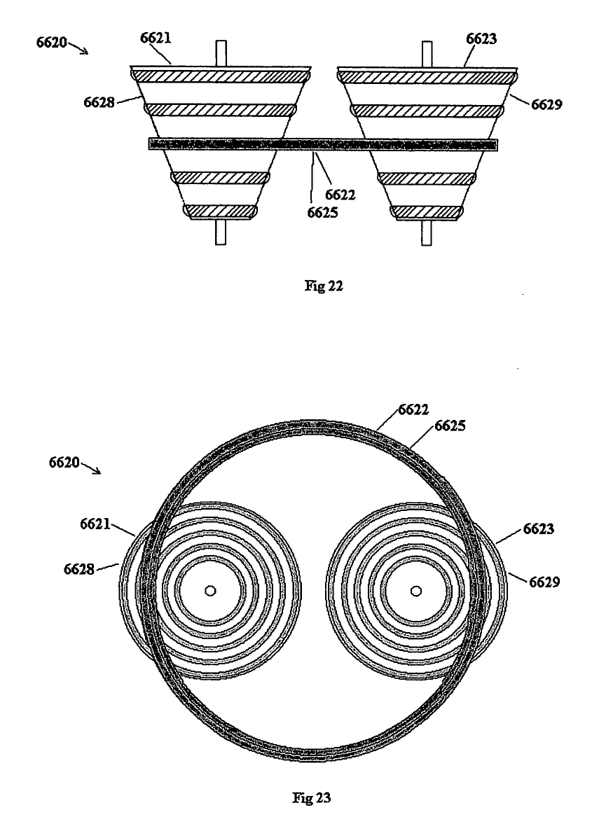

The third Tourgee Cascade 6620 embodiment, shown in FIGS. 21-23, is a friction tooth conic ring gear 6622 around two parallel friction tooth cones 6621, 6623, which utilizes an Anair surface interface. FIG. 21 is the extreme position 6624 of the ring 6622 around the small end of cone 6621 at position 6626, and the large end of cone 6623 at position 6627. As the cones 6621, 6623 move up and down in equal and opposite directions respectively and the ring 6622 moves laterally. To go from position 6624 to 6625, as shown in FIG. 22, the ring is moved to the left respectively. The cone 6621 moved to 6628 engaging the ring at position 6625 engaging a larger conic gear and cone 6623 moved to position 6625 engaging the ring 6622 at a smaller conic gear. FIG. 22 depicts the middle position where the ring is centered, while FIG. 23 is a bottom view of FIG. 22.

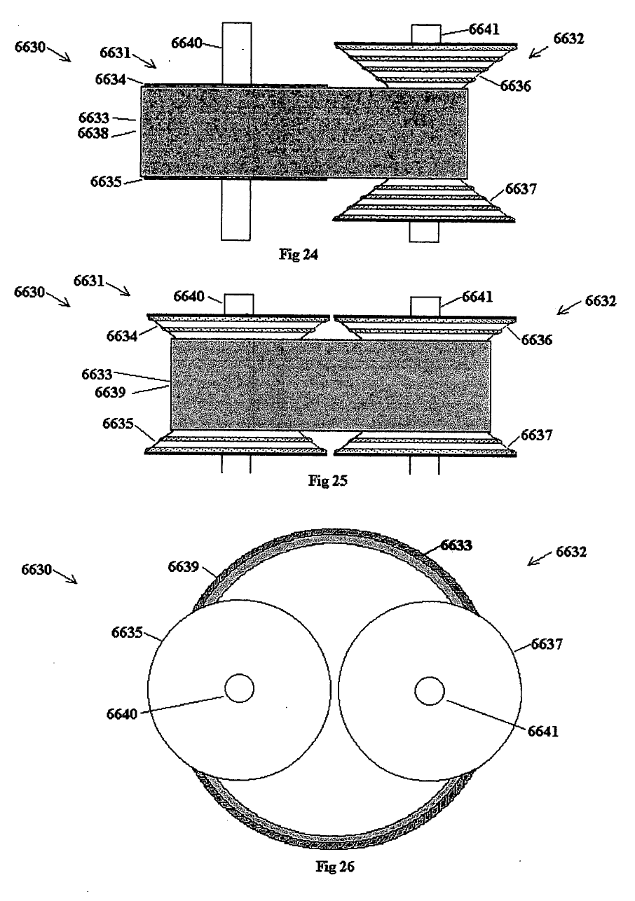

The forth Tourgee Cascade 6630 embodiment, shown in FIGS. 24-26, is a friction tooth ring gear 6633 around two sets of variable friction tooth cone pulleys 6631, 6632, which utilizes an Anair surface interface. The cone pulley 6631 consists of cone 6634 on the same shaft 6628 and in opposed direction with cone 6635. The cone pulley 6632 has cones 6636, 6637 disposed in opposite directions on shaft 6629. These cone pulleys 6631, 6632 work in equal and opposite directions. As one cone pulley 6631 is closing, the other cone pulley 6632 is opening. This maintains the equal distance that is the width of the conic ring gear 6633.

FIG. 24 diagrams the position 6638 with the ring gear 6633 is at the extreme left relative to the cone pulley shafts 6628,6629. The ring gear face 6640 is engaged with the conic teeth 6644 on cone 6634 and conic teeth 6642 on cone 6636. At the same time, the other connected ring gear face 6641 is engaged with the conic teeth 6645, 6645 on cones 6635, 6637 respectively.

FIGS. 25 and 26 show the ring gear 6633 in the middle of the two cone pulleys 6631, 6632 at position 6639. Here the ring gear face 6640 engages with conic gears 6646, 6648 and connected ring gear face 6641 engages with conic gears 6647,6649. The drawings show the conic gears 6642, 6643, 6644, 6645, 6646, 6647, 6648 and 6649 through cutouts of the ring gear 6633.

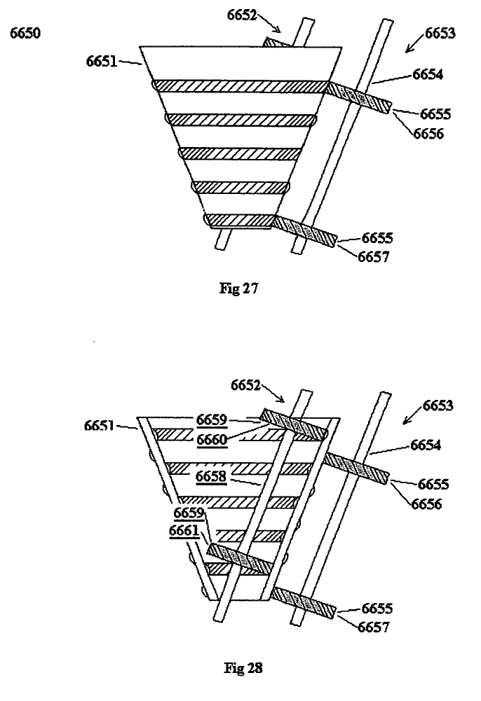

The Felch Cascade 6650, shown in FIGS. 27 and 28, is a hollow cone 6651 between two helical gears systems 6652, 6653, which utilizes a Tatham surface interface. FIG. 27 is an external view of the Felch Cascade 6650 showing the external gear system 6653, which includes a shaft 6654 with gear 6655; shown in two extreme positions 6656, 6657. FIG. 28 is a cut away view showing the internal gear system 6652, which includes gear 6659 on shaft 6658; again shown at two extreme positions 6660, 6661. Each of these gear systems 6652, 6653 is controlled independently via an external controller (not shown).

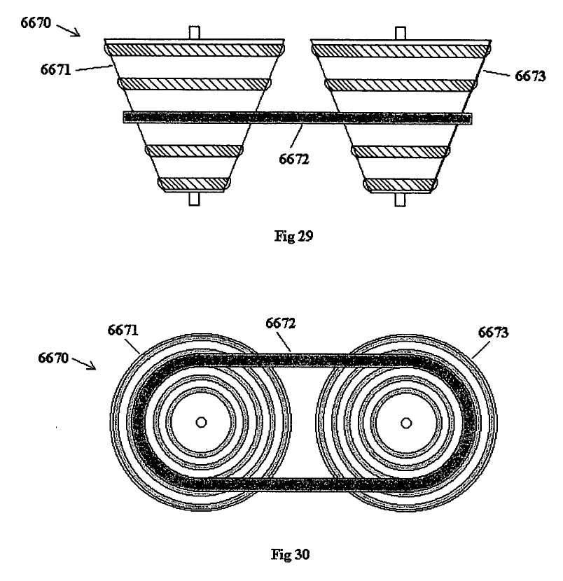

There are three Whicker cascades that are continuous loop belt/chain embodiments. FIGS. 29 and 30 show a transmission 6670 that includes a friction tooth continuous loop 6672 around two parallel friction tooth cones 6671,6673 and utilizes an Anair surface interface. As with all parallel cone embodiments, the cones move in equal and opposite directions and the continuous loop moves laterally respectively. The changes in the diameters of the conic gears 6673 are also equal and opposite. FIG. 30 shows a side view of the transmission 6670, while FIG. 30 is a bottom view of FIG. 29.

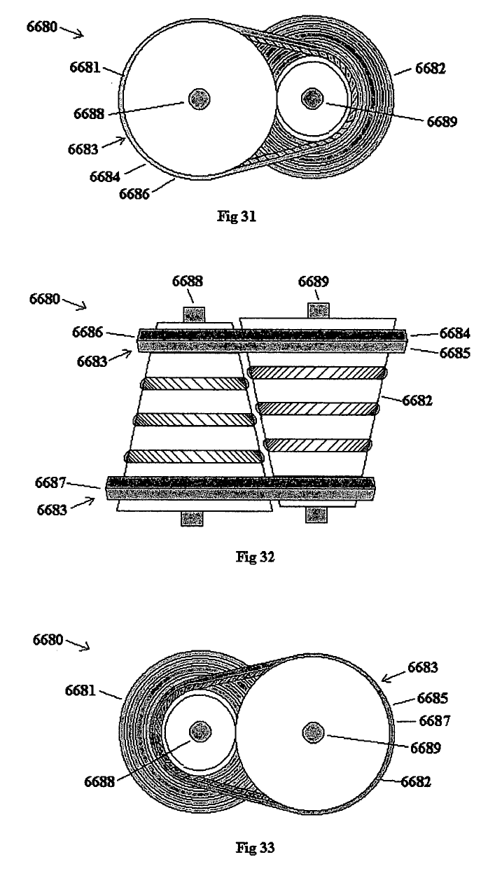

The transmission 6680 shown in FIGS. 31-33 is a friction tooth two-face continuous loop 6683 around two opposed friction tooth cones 6681, 6682 mounted on shafts 6688, 6689 respectively, and utilizing Anair surface interfaces on both faces. The two-faced continuous loop 6683 has one face 6684 of the loop engages with cone 6681 while the other face 6685 engages with cone 6682. This is the characteristic of a two-faced component, each face 6684, 6685 engages with a different cascading member. FIG. 32 is a side view of the diagram showing the continuous loop 6683 in two extreme positions 6686, 6687. FIG. 31 is a top view of FIG. 32 showing only the continuous loop face 6684 at position 6686, while FIG. 33 is a bottom view of FIG. 32 showing only the continuous loop face 6685 at position 6687. In these embodiments, the cones 6681, 6682 stay stationary while the continuous loop 6683 moves to change gear ratios.

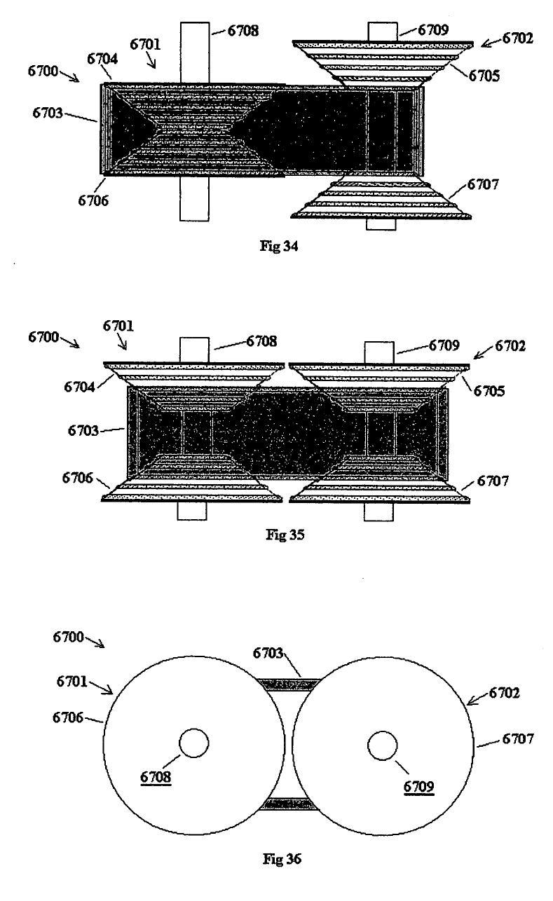

FIGS. 34-36 show embodiments of a Whicker Cascade 6700 of a friction tooth continuous loop 6703 around two sets of friction tooth variable cone pulleys 6701, 6702, which utilizes an Anair surface interface between the outside face 6709, 6710 of the continuous loop 6703 and the conic teeth in the variable cones 6704, 6705, 6706, 6707. The first conic pulley 6701 consists of a shaft 6708 with two opposed cones 6704, 6706 mounted on it. The second conic pulley has slideable cones 6705, 6707 on shaft 6709 in opposite directions, forming another conic pulley. The cones 6701, 6702 are slideable, thus forming a variable cone pulley.

FIG. 34 shows continuous loop 6703 in the extreme left position 6718 with its toothed face 6709 engaged with the conic teeth 6710 on cone 6704 and with the conic teeth 6712 on cone 6705. The other connected toothed face 6710 is engaged with conic teeth 6711, 6713 on cones 6706, 6707 respectively.

FIGS. 35 and 36 show the continuous loop 6703 in the middle position 6719 with its toothed face 6709 engaged with conic teeth 6714, 6716 and the other toothed face engaged with conic teeth 6715, 5717.

The variable pulleys 6701, 6702 move in opposite and equal directions relative to each other. The effect is the faces 6709, 6710 of the continuous loop are always against the conic surface of the conic pulleys. As the contact surface of pulley 6701 becomes larger, pulley 6702 becomes equally smaller, maintaining the consistency of contact with the constant width and length loop. The references 6711, 6712, 6713, 6714, 6715, 6716, 6717 and 6718 are cut away views through the continuous loop 6703.

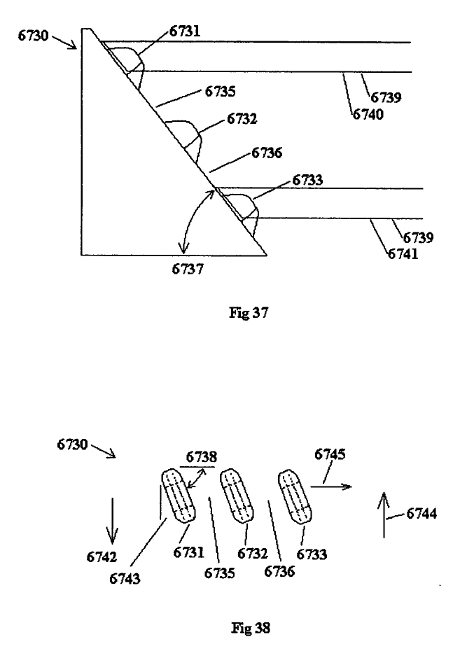

FIGS. 37-38 depict a part of a cross section of conic pulley 6707. FIG. 37 is the cross section 6730, while FIG. 38 is top view of FIG. 37 showing the faces of the teeth 6731,6732,6733. The tapered teeth 6731,6732,6733 in FIG. 38 demonstrate contact with the continuous loop 6703 at the top conic gear 6713 and at the middle conic gear 6717. The tooth space 6735, 6736 is the friction contact area when the continuous loop moves from one conic teeth to another.

Applying the conix formula with angle 6737 yields a large helix angle 6738. The resulting teeth in FIG. 38 look very flat, which is not practical for gear teeth. However, a continuous loop is different in that the contact is a large percentage of the conic of teeth, providing two dynamics that can be exploited. First, the contact face of the belt/chain would be wedged 6743 against the tooth 6731 if the belt were traveling in the relative direction of arrow 6742. This wedging would pull the belt taught. Second, if the belt were traveling in direction of arrow 6744, the teeth would compress in the direction of arrow 6745 relatively. The wedging would pull on a belt, thus making this the preferred method for a flexible belt. The compression would push against a chain, thus making this the preferred method for the chain. The wedging would work on the chain as well, but having the wear pattern on the outside of the conic teeth may be more desirable to the inside.

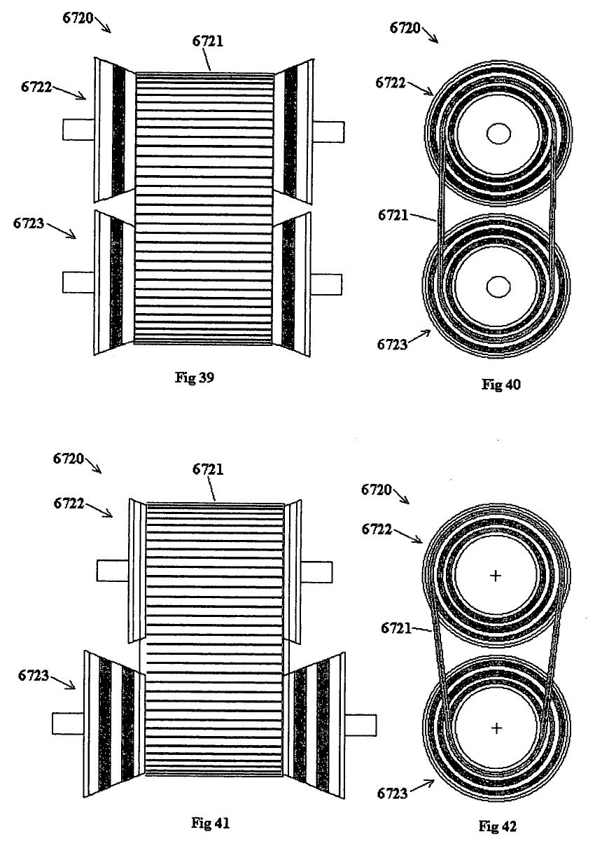

FIGS. 39-42 show another friction tooth continuous loop embodiment 6720 with a chain 6721 around two variable cone pulleys 6722, 6723. Cone pulley 6722 has two cones 6740, 6741 in opposite directions on shaft 6744. Cone pulley 6723 has cones 6742, 6743 on shaft 6745 in opposite directions. These cone pulleys open and close in equal and opposite directions maintaining the contact width of chain 6721.

FIG. 39 shows cone pulleys 6722, 6723 in their middle positions 6746, 6747 respectively. The chains 6721 face 6727 is engaged with the conic gear 6730 on cone 6740 and with conic gear 6732 on cone 6742. The other connected face 6728 is engaged with conic gears 6731,6733 on respective cones 6741, 6743. FIG. 40 is a side view of cross-section 6725 of FIG. 39 showing the relative position of the chain 6721 on the middle conic gears 6730,6732.

FIG. 41 has the cone pulleys 6722, 6723 in the extreme positions 6748, 6749 respectively. The chain 6721 has its face 6727 engaged with conic gears 6734,6736 and face 6728 with conic gears 6735,6738 respectively. FIG. 41 is the side view cross-section 6726 of FIG. 41 showing the chain 6721 on the largest conic gear 6734 and the smallest conic gear 6736.

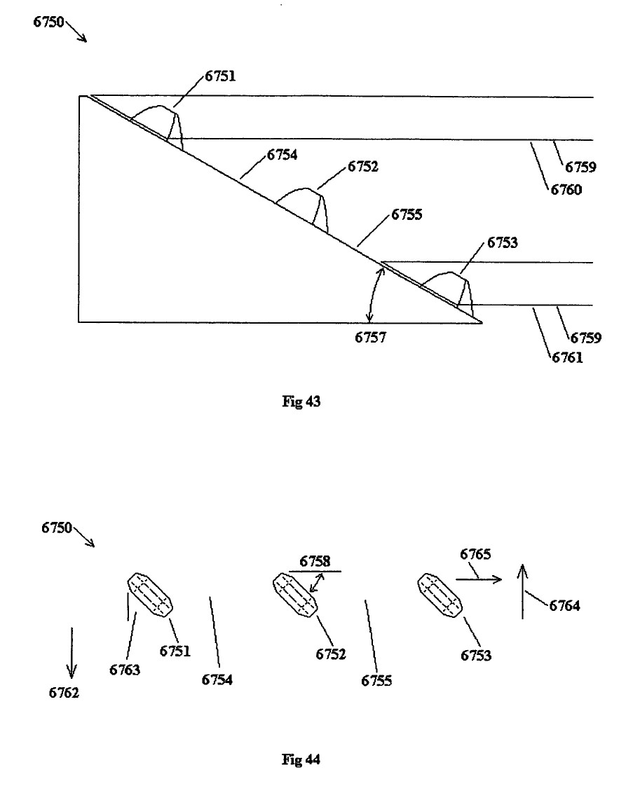

FIGS. 43 and 44 show portions of the cone 6740. The tapered teeth 6751, 6752, 6753 in FIG. 43 demonstrate the contact with the continuous loop 6721 at the top position 6734 and bottom position 6760. The tooth spaces 6754, 6755 are the friction contact area when the continuous loop moves from one ring of teeth to another.

Applying the conix formula with angle 6757 produces a steeper helix 6758. This effect is that the wedge 6763 created when the belt is moving in the relative direction of arrow 6762 is larger, and thus a stronger contact between teeth. The compression 6765 when the belt is moving in the relative direction of arrow 6764 is reduced. Therefore, a smaller conix angle in transmission 6720 is better for a chain that is utilizing compression and a larger conix angle in transmission 6700 is better for a belt utilizing the wedging dynamics.

The smaller the conix, the larger the relative space between the teeth 6754,6755. Compared to FIG. 37, the tooth space 6735,6736 is smaller and the conix larger with belt 6703 the same width as 6721. In the embodiment of FIG. 43, the smaller conix means the rings of teeth have to be further apart or the width of the teeth 6751, 6752, 6753 have to be reduced in size.

The contrast between different conix angles shown is how the concept is applied. A stiff belt can be compressed, but being stretch taught may be the preferred method. This in turn means shorter conic pulleys. The compression on a chain with a small helix from a small conix would make the conic pulleys larger and the length of the conic face longer. This is the most useful of the surface friction tooth applications, as it has broad surface contact, and the controls on are the variable cones, not touching the belt/loop.

Finally, all the friction tooth concepts presented have been shown without control systems. However, the current art of positioning systems for external gears, internal ring gears, belts, chains and variable pulleys already exist and are would be recognized and readily applied by those of ordinary skill to the systems of the present invention.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

1. A gear train apparatus comprising:
at least one cone comprising a plurality of friction teeth;
wherein said plurality of friction teeth are arranged about said cone to form a plurality of conic rings disposed about a plurality of nascention circles of said cone;
wherein said conic rings define a plurality of friction rings disposed between said conic rings of friction teeth; and
wherein each of said friction teeth comprises a mid-section dimensioned as a conic tooth having a clearance space of a diameter less than a diameter of a corresponding position on a cone formed by said plurality of friction rings; and
at least one mating member comprising a plurality of mating teeth, said mating teeth dimensioned to engage said friction teeth when said mating member is aligned with one of said plurality of conic rings and dimensioned to frictionally engage one of said plurality of friction rings when said mating member is aligned with one of said plurality of friction rings;
wherein said mating member is arranged relative to said cone such that said mating member engages said conic rings such that said gear train operates as a toothed drive and engages said friction rings such that said gear train operates as a friction drive when moving from one conic ring to another conic ring.

2. The gear train as claimed in claim 1 wherein each of said plurality of friction teeth further comprises a pair of sloped ends.

3. The gear train as claimed in claim 1 wherein said mating member is a pinion gear.

4. The gear train as claimed in claim 3 wherein said pinion gear comprises a plurality of teeth each having a top comprising a cushioning material that dimensioned to be compressed when engaged with a mating friction tooth.

5. The gear train as claimed in claim 3 wherein said gear is a two-faced conic gear, wherein said at least one cone comprises two cones disposed in opposed positions, and wherein said two faced conic gear is disposed between, and engages, each of said two cones.

6. The gear train as claimed in claim 3 wherein said gear is a helical gear, wherein said at least one cone comprises two cones disposed in opposed positions, and wherein said helical gear is disposed between, and engages, each of said two cones.

7. The gear train as claimed in claim 3 wherein said gear is a conic gear, wherein said at least one cone comprises two cones disposed in parallel relation, wherein said helical gear is disposed between, and engages, each of said two cones, and wherein at least one of said cones is movable in relation to another of said cones.

8. The gear train as claimed in claim 1 wherein said at least one cone comprises two sets of cones disposed upon two parallel shafts such that each set of cones is in opposite orientation sharing a shaft.

9. The gear train as claimed in claim 1 wherein said at least one cone comprises two cones and wherein said mating member is a helical ring gear.

10. The gear train as claimed in claim 1 wherein said at least one cone comprises two cones and wherein said mating member is a helical ring gear.

11. The gear train as claimed in claim 1 wherein said at least one cone comprises two cones and wherein said mating member is a continuous loop.

12. The gear train as claimed in claim 1 wherein said at least one cone comprises two cones and wherein said mating member is a chain.
